(19) United States
(12) Patent Application Publication
(10) Pub. No.: US 2009/0256767 A1
(43) Pub. Date: Oct. 15, 2009

(54) SYMMETRICAL MATRIX REPRESENTATION OF DIPOLE UWB ANTENNA

(75) Inventors: CHING-NENG KAN, Taoyuan County (TW); HSUAN-YI KUO, Taoyuan County (TW)

Correspondence Address: WPAT, PC, 7225 BEVERLY ST., ANNANDALE, VA, 22003, US

(73) Assignee: KINSUN INDUSTRIES INC., Taoyuan County (TW)

(21) Appl. No.: 12/100,057

(22) Filed: Apr. 9, 2008

(51) Int. Cl. H01Q 9/16

(52) U.S. Cl. 343/795

(57) ABSTRACT

A symmetrical matrix representation of dipole UWB antenna, mounted on a substrate and attachable to a wireless communication apparatus, comprises a first radiation arm, said first radiation arm comprising a first feed point, a first branch, a second branch, and a third branch, said first branch, said second branch, and said third branch are spaced in parallel, said first feed point and said second branch are aligned; and a second radiation arm, said second radiation arm comprising a second feed point, a fourth branch, a fifth branch, and a sixth branch, said fourth branch, said fifth branch, and said sixth branch are spaced in parallel, said first feed point and said second branch are aligned; wherein said first feed point and said second feed point are interconnected to a wireless communication apparatus.

### BACKGROUND OF THE INVENTION

1. Field of the Invention

The present invention related to a symmetrical matrix representation of dipole UWB antenna and, more particularly, to the antenna mounted upon a substrate. Said antenna comprising a first radiation arm and a second radiation arm, and the width and the length of said first radiation arm and said second radiation arm are designed according to frequency response match demand.

2. Description of the Related Art

As the modern communication technology gets ahead, wireless communication devices are largely used in notebooks, cellular phones and PDA to serve the wireless communication purposes. In general, wireless communication devices will use built-in antenna due to their prettier outlooks. However; the popular built-in antenna sacrificed its bandwidth and radiation efficiency in order to benefit from its size shrink, said antenna is of bad characteristics and uneasy to adjust to the certain frequency response for the corresponding electronic products, or its bandwidth range is very small. The present invention is a solution of antenna structure to overcome the above problems.

### SUMMARY OF THE INVENTION

The following description of various embodiments of antenna designs and methods is not to be construed in any way as limiting the subject matter of the appended claims. The major purpose for the present invention is to build a symmetrical matrix representation of dipole UWB antenna mounted on a substrate, and said antenna comprises a first radiation arm and a second radiation arm. Through the calculation of the length and width of the first radiation arm and the second radiation arm, the frequency response can be adjusted according to the match demand.

Another purpose for the present invention is to easily and simply mass productions and improving the yield by the structure setting on the substrate.

Yet another purpose for the present invention is to increase radiation surfaces according to the actual demand thus the symmetrical matrix representation of dipole UWB antenna can receive and transmit electromagnetic wave at different frequencies.

In order to achieve the goals mentioned above, the present invention related to a symmetrical matrix representation of dipole UWB antenna, mounted on a substrate and attachable to a wireless communication apparatus, comprises a first radiation arm, said first radiation arm comprising a first feed point, a first branch, a second branch, and a third branch, said first branch, said second branch, and said third branch are spaced in parallel, said first feed point and said second branch are aligned; and a second radiation arm, said second radiation arm comprising a second feed point, a fourth branch, a fifth branch, and a sixth branch, said fourth branch, said fifth branch, and said sixth branch are spaced in parallel, said first feed point and said second branch are aligned; wherein said first feed point and said second feed point are interconnected to a wireless communication apparatus, said first feed point and said second feed point are located at the nearest location from the first radiation arm and the second radiation arm respectively

### BRIEF DESCRIPTION OF THE DRAWINGS

Other objectives and advantages of the invention will become apparent upon reading the following detailed description and upon reference to the accompanying drawings in which:

FIG. 1 is the first embodiment of the symmetrical matrix representation of dipole UWB antenna according to the present invention;

FIG. 2 is a frequency response plot of FIG. 1;

FIG. 3 is the second embodiment of the symmetrical matrix representation of dipole UWB antenna according to the present invention;

FIG. 4 is the third embodiment of the symmetrical matrix representation of dipole UWB antenna according to the present invention; and

FIG. 5 is the fourth embodiment of the symmetrical matrix representation of dipole UWB antenna according to the present invention.

While the according invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF PREFERRED EMBODIMENTS

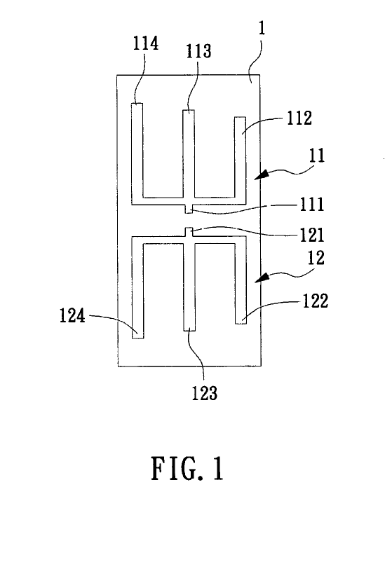

Turning now to the drawings, FIG. 1 illustrates a first embodiment of the symmetrical matrix representation of dipole UWB antenna. It is attachable to wireless communication apparatus, and the symmetrical matrix representation of dipole UWB antenna is mounted on a substrate 1, said substrate 1 is selected from a PCB and metal radiation slice therefore its manufacturing cost is lower than conventional cylinder antenna or spiral antenna. Meanwhile, it is thinner, lighter, shorter, and smaller than prior-art antenna. Said antenna comprises: A first radiation arm 11, 11 comprises a first feed port 111, a first branch 112, a second branch 113 and a third branch 114. 112, 113, and 114 are parallel to each other. 11 and 113 are aligned; a second radiation arm 12, 12 comprises a second feed port 121, a fourth branch 122, a fifth branch 123 and a sixth branch 124. 122, 123, and 124 are parallel to each other. Said 12 and said 121 are aligned; said 111 and said 121 are used to interconnect to wireless communication apparatus (For instance, notebook, cellular phone or PDA, which is not illustrated in the drawings).

The first feed port 111 and the second feed port 121 are located at the nearest spot from the first radiation arm and the second radiation arm respectively. In the first radiation arm 11, the right spike of back side of horizontal line for the first feed port 111 is the first branch 112, the left spike of back side of horizontal line for the 111 is the third branch 114, and the conterminous spike of back side of horizontal line for the 111 is the second branch 113, as mentioned, 112, 113, and 114 are parallel to each other to form the first radiation arm 11; and in the second radiation arm 12, the right spike of back side of horizontal line for the first feed port 121 is the fourth branch 122, the left spike of back side of horizontal line for the 121 is the sixth branch 124, and the conterminous spike of back side of horizontal line for the 121 is the fifth branch 123, as mentioned, 122, 123, and 124 are parallel to each other to form the first radiation arm 11.

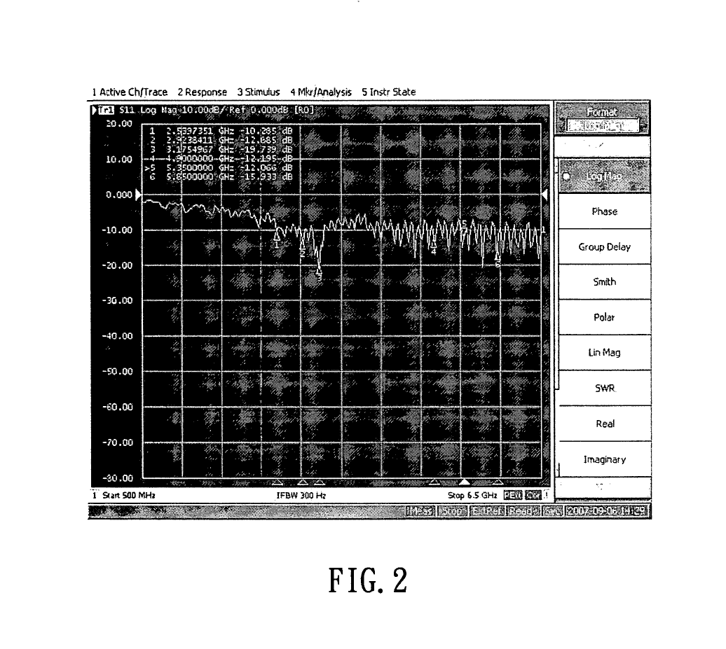

As suggested by FIG. 2, it related to the antenna frequency response linear plot of FIG. 1., wherein the antenna illustrated in FIG. 1 shows the minimum of the antenna frequency horizontal (x) axis is 500 MHz, and the maximum is 6.5 GHz. Its vertical (y) axis, related to reflection loss (dB). Skilled person in the art can understand, according to the plot of FIG. 2, within the range of ultra wide band (500 MHz˜6.5 GHz) the antenna frequency response can keep a steady frequency response value. Mainly, the first branch 112, the second branch 113 and the third branch 114 of the first radiation arm 11 as well as the fourth branch 122, the fifth branch 123, and the sixth branch 124 of the second radiation arm 12 were constituted a UWB antenna at λ (wavelength)/4 according to different frequencies.

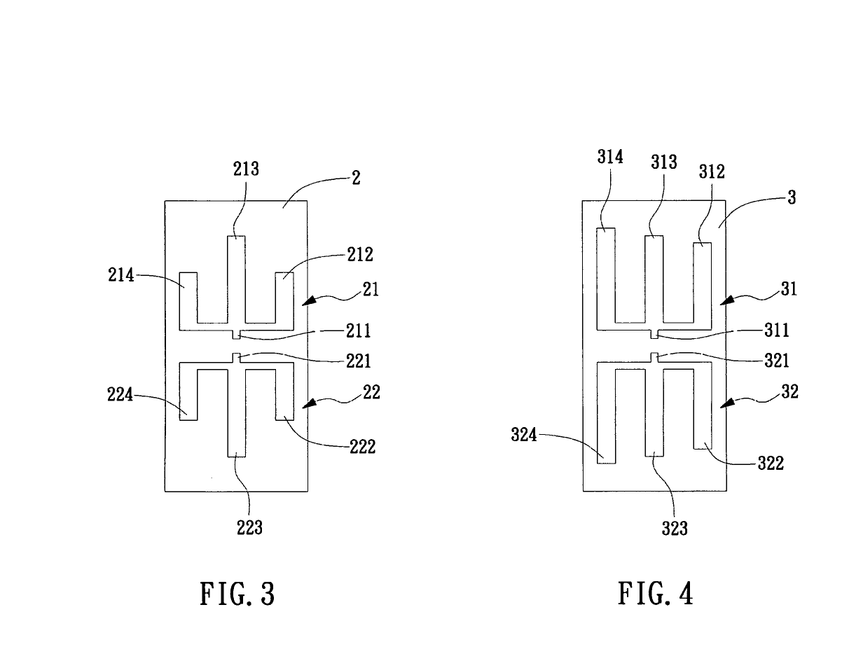

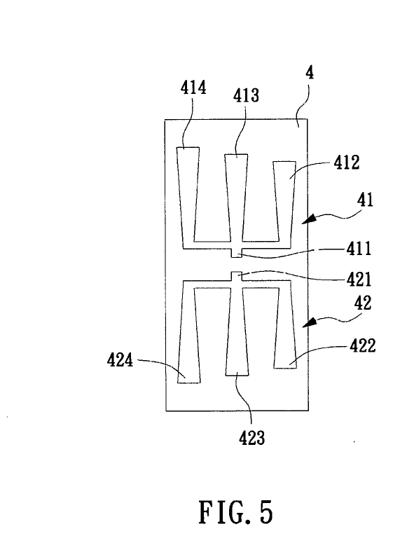

The following structures disclosed in FIG. 3, FIG. 4, and FIG. 5, corresponds to the 2^{nd}, 3^{rd}, and 4^{th} embodiments of symmetrical matrix representation of dipole UWB antenna. All alternatives and modifications relates to the 1^{st}, 2^{nd}, and 3^{rd} branches of the 1^{st} radiation arm as well as the 4^{th}, 5^{th}, 6^{th} branches of the 2^{nd} radiation arm. The width or length of the structures can be altered or changed in order to introduce the different frequency response match in order to meet the characteristics for modern electronic products.

Referring to FIG. 3, it relates to the second embodiment of the symmetrical matrix representation of dipole UWB antenna. The antenna structure on PCB 2 comprises: a first radiation arm 21, said 21 comprises a first feed point 211, a first branch 212, a second branch 213, and a third branch 214; a second radiation arm 22, said 22 comprises a second feed point 221, a fourth branch 222, a fifth branch 223, and a sixth branch 224. Compared with FIG. 1, the most significant different is that the 1^{st} branch 212 and the 3^{rd} branch 214 on the 1^{st} radiation arm 21 are both shorter than the 2^{nd} branch 213. Also, the 4^{th} branch 222 and the 6^{th} branch 224 are both shorter than the 5^{th} branch 223. Said all six branches are wider than those illustrated in FIG. 1. To change the length or width of the 1^{st} radiation arm and the 2^{nd} radiation arm can affect the waveform of antenna frequency response.

Also referring to FIG. 4, it relates to the third embodiment of the symmetrical matrix representation of dipole UWB antenna. The antenna on the substrate comprises: a first radiation arm 31, 31 comprises a 1^{st} feed point 311, a 1^{st} branch 312, a second branch 313 and the 3^{rd} branch 314; a 2^{nd} radiation arm 32, 32 comprises a 2^{nd} feed point 321, a 4^{th} branch 322, a 5^{th} branch 323 and the 6^{th} branch 324. Compared with FIG. 1, the most significant different is that the width for the six branches is wider than that disclosed in FIG. 1 in order to meet the specific demand for antenna feed point of electronic products.

Also referring to FIG. 5, it relates to the fourth embodiment of the symmetrical matrix representation of dipole UWB antenna. The antenna on the substrate comprises: a first radiation arm 41, 41 comprises a 1^{st} feed point 411, a 1^{st} branch 412, a second branch 413 and the 3^{rd} branch 414; a 2^{nd} radiation arm 42, 42 comprises a 2^{nd} feed point 421, a 4^{th} branch 422, a 5^{th} branch 423 and the 6^{th} branch 424. Compared with FIG. 4, the most significant different is that the width for the six branches is wider at the end closer to two feed points and is thinner at another end farther to two feed points. In addition to match different frequency responses, such a structure also meets the specific demand of electronic products for antenna feed points.

According to the disclosures from FIG. 1 to FIG. 5, the person skilled in the art can understand that the main purpose of the present invention is to disclose a symmetrical matrix representation of dipole UWB antenna mounted on a substrate, said antenna comprises a first radiation arm and a second radiation arm, and the desirable frequency response for matching is achieved by adjusting the width or/and length of said radiation arms. Meanwhile, the antenna, since mounted on the substrate, can be easy for mass production and for good yield. Further more, the radiation surfaces can be adjusted according to actually demand thus the antenna can transmit and receive the electromagnetic waveforms at different frequencies.

It will be appreciated to those skilled in the art having the benefit of this disclosure that this invention is believed to provide a practical implementation of antenna. Further modifications and alternative embodiments of various aspects of the invention will be apparent to those skilled persons in view of this description. The specification and drawings are to be regarded in an illustrative rather than a restrictive sense.

What is claimed is:

1. A symmetrical matrix representation of dipole UWB antenna, mounted on a substrate and attachable to a wireless communication apparatus, comprising
a first radiation arm, said first radiation arm comprising a first feed point, a first branch, a second branch, and a third branch, said first branch, said second branch, and said third branch are spaced in parallel, said first feed point and said second branch are aligned; and
a second radiation arm, said second radiation arm comprising a second feed point, a fourth branch, a fifth branch, and a sixth branch, said fourth branch, said fifth branch, and said sixth branch are spaced in parallel, said first feed point and said second branch are aligned;
wherein said first feed point and said second feed point are interconnected to a wireless communication apparatus, said first feed point and said second feed point are located at the nearest spot from the first radiation arm and the second radiation arm respectively.

2. The dipole UWB antenna as recited in claim 1, wherein a conterminous line of said first branch corresponding to said fourth branch.

3. The dipole UWB antenna as recited in claim 1, wherein a conterminous line of said second branch corresponding to said fifth branch.

4. The dipole UWB antenna as recited in claim 1, wherein a conterminous line of said third branch corresponding to said sixth branch.

5. The dipole UWB antenna as recited in claim 1, wherein said substrate selected from the group of PCB and metal radiation slice.

6. The dipole UWB antenna as recited in claim 1, wherein said first branch, second branch, third branch, fourth branch, fifth branch, and six branch are λ/4, said λ is the wavelength corresponding to different frequencies.
